(19) United States
(12) Patent Application Publication
(10) Pub. No.: US 2007/0147932 A1
(43) Pub. Date: Jun. 28, 2007

(54) Computer keyboard

(76) Inventor: Susan L. Giles, San Mateo, CA (US)

Correspondence Address: Todd A Noah;Dergosits & Noah, Suite 1450, Four Embarcadero Center, San Francisco, CA, 94111, US

(21) Appl. No.: 10/583,756

(22) PCT Filed: Jan. 6, 2005
(86) PCT No.: PCT/US05/00283

§ 371 Date: Jun. 21, 2006

Related U.S. Application Data
(60) Provisional application No. 60/534,664, filed on Jan. 6, 2004.

(51) Int. Cl. B41J 5/00

(52) U.S. Cl. 400/472

(57) ABSTRACT

A computer keyboard that includes features which assist a child in learning how to type. The keys have different colors based upon the function of the keys. The number keys are physically separated from the letter keys by a gap to prevent accidental contact with the number keys while typing words. The keyboard includes a mechanism which disables the normal repeat function. This mechanism prevents the repeated typing of a letter or number regardless of how long the key is pressed.

### BACKGROUND

The origin of the modern computer keyboard began with the invention of the typewriter in 1867. The industry standard keyboard layout is the QWERTY keyboard because of the arrangement of the keys in the upper row. When electric typewriters and computers were developed, the typewriter QWERTY layout was retained even though the keys were connected to electrical switches rather than mechanical typing mechanisms. In particular, the keyboards were designed to repeatedly input any key that is held down.

As computers and electric typewriters advanced, the keyboard layouts also changed. In addition to the letter and number keys, special function keys were added to control various computer program functions. Cursor keys that control the cursor position and a numeric keypad for faster numeric input were also added to computer keyboards. While these additional keys enhanced the functionality of the keyboard, they also made the keyboard more complex and confusing. Because there are so many control keys, modern computer keyboards can be intimidating to children and beginning computer users.

### SUMMARY OF THE INVENTION

The inventive keyboard is a simplified keyboard that is intended to help children learn how to use computers. The keyboard assists children by color coding each of the keys based upon function. In addition to being marked with the QWERTY letter, the consonant keys are in a first color and the vowel keys in a second color. For example, the consonant keys may be orange and the vowel keys may be red. This visual distinction helps the child learn the location of the letters on the keyboard.

The keys of the inventive keyboard are also color coded. The number keys are a color that is distinct from the consonant letters such as red. The “enter” and cursor keys of the keyboard are a third color and all other functional keys are in a fourth color. In an embodiment, the enter and cursor keys are purple and the other functional keys are blue.

In addition to the keys themselves being color coded, the markings on the keys are also color coded. In general most functional text and letters are marked on the keys in a uniform color that contrasts with the color of the keys. However, the “shift” text on the shift keys are in a color that differs from the other letters and text. Where a symbol corresponds to a key, the symbol is marked on the key in a color that matches the shift key text. Thus, it is easier to explain to children that when the shift key and a number key are pressed simultaneously, the symbol on the key matching the color of the shift key text will be transmitted.

The inventive keyboard also uses a simplified set of keys. The nonessential function keys that are normally on the keyboard have been completely removed. By removing these keys, the child can more easily learn to type. Because the inventive keyboard also differs from normal keyboards, number/symbol keys which are normally in very close proximity to the top row of letter keys have been separated by a gap from the letter keys. This gap separation of the number/symbol keys adds distance to avoid unintentional key strokes.

Yet another feature of the inventive keyboard is the removal of the repeat function from all keys other than the hyphen, enter, space and cursor arrow keys. When children learn to type, they tend to type very slowly as they learn the locations of each letter and number key on a keyboard. While learning to type, children tend to press and hold the keys down for too long. On a normal keyboard, this would result in the key being repeatedly input and displayed across the computer screen. The inventive keyboard overcomes this repeating problem by disabling the repeat function. This allows children to type at a very slow pace without inadvertently engaging the repeat function. After the children become proficient with the inventive learning keyboard, they can switch to a normal computer keyboard and use the repeat function.

### DESCRIPTION OF THE DRAWINGS

FIG. 1 is a top view of the inventive keyboard;

FIG. 2 is cut away view of the inventive keyboard; and

FIG. 3 is a top view of a hand.

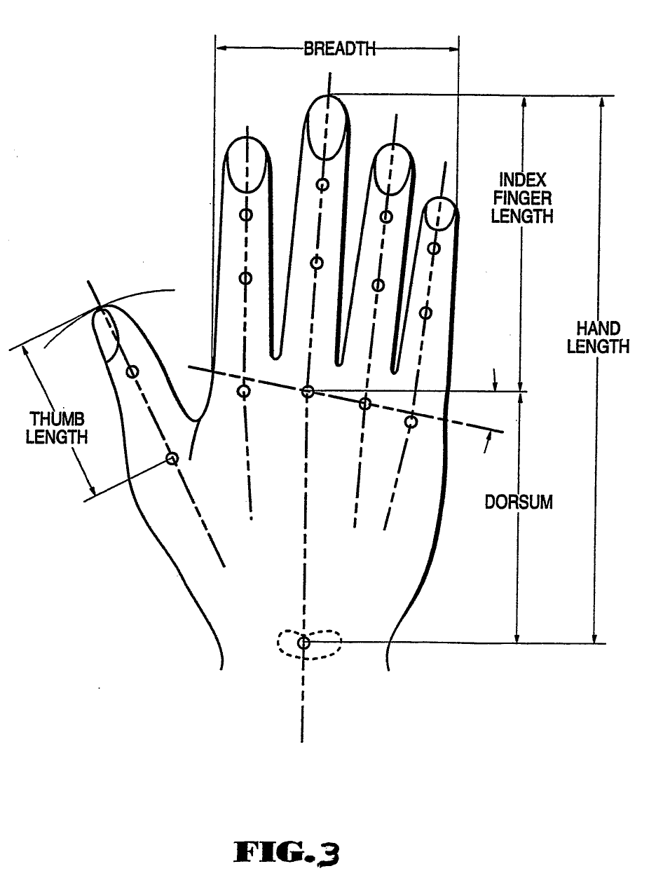

### DETAILED DESCRIPTION

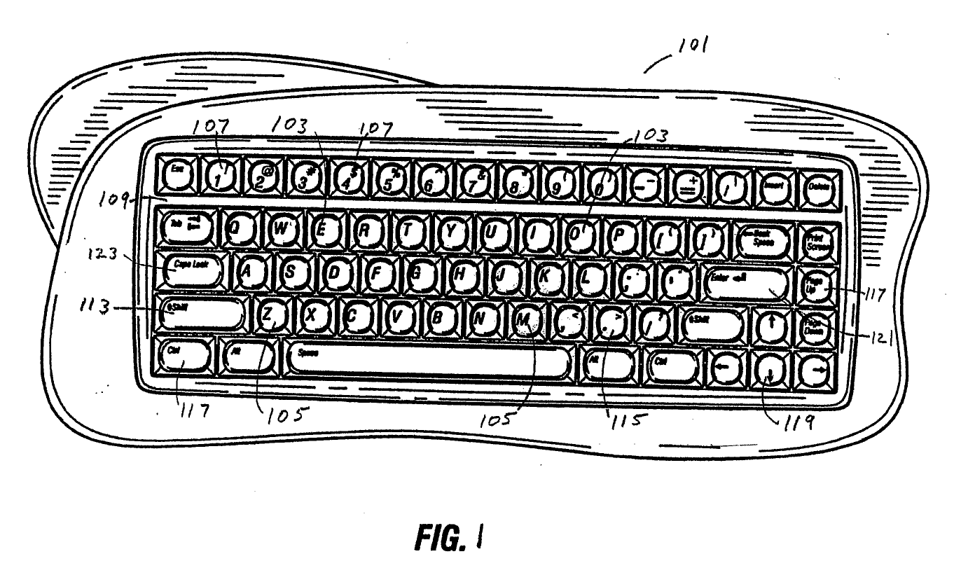

The present invention is a keyboard designed for children. With reference to FIG. 1, the inventive keyboard uses the standard QWERTY layout but includes several design features that allow the keyboard to be more easily used by children. Various features differentiate the inventive keyboard from existing keyboards. The inventive keyboard has color coded keys which differ from existing keyboards. The keys of the inventive keyboard are grouped by color depending upon the type of key or functionality.

In an embodiment, the vowel keys 103 A, E, I, O and U are red and the consonant keys 105 are orange. In alternative embodiments the vowel keys 103 may be any color which is distinct in color from the consonant keys 105. This contrast between the vowel keys 103 color and the consonant keys 105 color allows the child to more easily find the vowels which are used in nearly all English words. Because the vowel keys 103 and consonant keys 105 are distinctly colored, the child will be able to quickly learn the locations of the letters which will result in faster typing. The child will also more easily learn that almost all words are spelled by using combinations of consonant keys 105 in orange and vowel keys 103 in red.

In order to further assist the user, the number keys 107 at the top of the keyboard 100 are physically separated by a gap 109 from the letter keys 103, 105. This spacing gap 109 also helps children learn to type. When the user presses the top row of letter keys, the gap 109 helps to prevent accidental contact with the number keys 107. With a conventional computer keyboard, the number keys are placed directly adjacent to the upper row of letter keys. It is very easy to accidentally press a number key rather than a letter key because the number keys are placed very close to the upper row of letter keys. The inventive keyboard separates the number keys 107 and letter keys 103, 105 which helps to reduce this problem.

The inventive keyboard also distinguishes the number keys 107 by using a distinct color. In an embodiment the number keys 107 are red. In other embodiments, the number keys 107 can be any color that is distinct from the color of the consonant keys 105. The distinctive color and physical separation of the number keys 107 helps children to differentiate the number keys 107 from the letter keys 103, 105.

It is well known that when the shift key 113 and another key are pressed simultaneously, the character typed will be different than when the shift key 113 is not pressed. However, when the shift key 113 and any letter key 103, 105 are pressed, the upper case letter will be typed. When the shift key 113 and a number key 107 are pressed, a symbol will be typed. These symbols are printed on the upper portion of the number keys 107. The symbols corresponding to each of number keys are listed in Table 1 below.

TABLE 1

| Shifted | ! | @ | # | $ | % | \hat{ } | & | * | ( | ) |
|---|---|---|---|---|---|---|---|---|---|---|
| Unshifted | 1 | 2 | 3 | 4 | 5 | 6 | 7 | 8 | 9 | 0 |

The inventive keyboard also includes symbol keys 111 and punctuation keys 115. Like the number keys 107, these symbol keys 111 and punctuation keys 115 produce different symbols or punctuation marks when pressed simultaneously with the shift key 113.

TABLE 2

| | | | | | | | | | | |
|---|---|---|---|---|---|---|---|---|---|---|
| Shifted | < | > | ? | $ | % | ( | ) | _{—} | + | \| |
| Unshifted | , | . | / | ; | ‘ | [ | ] | - | = | \ |

The inventive keyboard also has a set of essential functional keys 117 which are in colors different from the number keys 107 and letter keys 103, 105. In an embodiment the functional keys 117 are blue. These functional keys 117 are necessary in order to use the keyboard with the computer. Pressing the functional keys does not print text on the computer screen but may alter the output of the keys or control the computer cursor position on the displayed page. The functional keys 117 include: ctrl, alt, space, shift, caps lock, tab, esc, insert, delete, back space, print screen, page up and page down. These keys are generally not effected by pressing the shift key.

The inventive computer keyboard 101 also includes an “enter” key 121. The enter key 121 of the inventive keyboard is distinctive in color. That contrasts with the number keys 107 and letter keys 103, 105. In an embodiment, the enter key 121 is purple. This color contrast is intended to again distinguish the enter key from all other keys and assist in teaching the child where the enter key 121 is located. When a child is learning to use a computer, the enter key 121 can be located by instructing the child to press the rectangular purple key.

The computer keyboard 101 also includes cursor keys 119 which are directional arrows: ←, ↑, ↓ and →. The cursor keys 119 normally control the position of a cursor displayed on the computer monitor. In an embodiment of the keyboard, the cursor arrow keys 119 are also purple.

In addition to the special coloring of the keys of the inventive keyboard, the text printed on each of the keys may have special significance. In the preferred embodiment, the symbols which are actuated by pressing the shift key 117 and a number key 107 are printed on the keys in a color that matches the shift key 117 text color. Because these colors match, the child will be reminded that the shift key 117 needs to be pressed in order to type the symbol or punctuation mark associated with the number keys 107. In an embodiment, the shift key 117 text is white and the text symbol produced when the shift key 117 is pressed is also white.

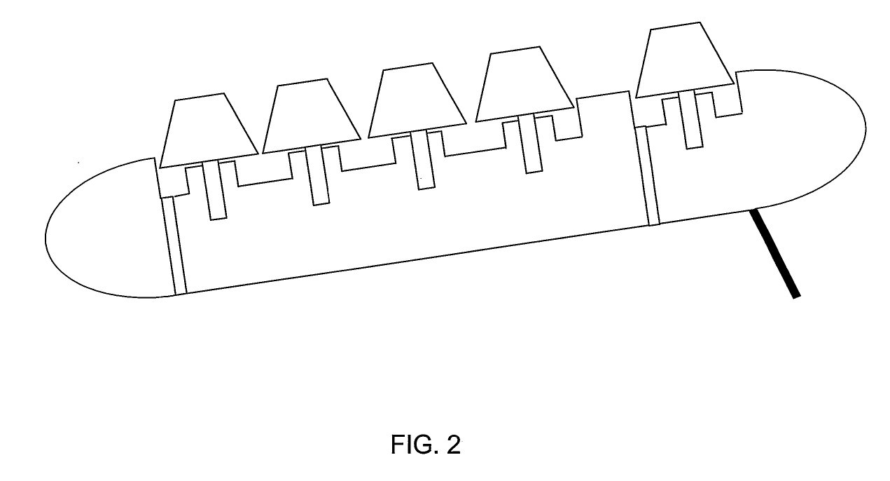

As discussed, the keyboard is designed for a child's hand rather than an adult hand. The spacing of the keyboard keys may be shorter allowing children and users with small hands to more easily reach the desired keys. In an embodiment, the overall inventive dimensions of the keyboard are proportional to the average sized child's hand. Table 3 lists average dimensions in inches for various hand parameters of children 4, 6 and 8 years of age and an adult hand for comparison. The dimensions of the adult male hand are substantially greater in size than the average child's hand. FIG. 2 illustrates the location of the listed dimensions on a hand. In order to accommodate the smaller dimensions of children's hands, the size and spacing of the inventive keyboard can be proportionally smaller than an adult keyboard.

TABLE 3

| | 4 year old | 6 year old | 8 year old | |
|---|---|---|---|---|
| | child | child | child | Adult male |
| Hand length | 4.6 | 5.1 | 5.6 | 7.5 |
| Hand Breadth | 2.1 | 2.3 | 2.5 | 3.5 |
| Index finger length | 2.6 | 2.9 | 3.2 | 4.5 |
| Dorsum length | 1.8 | 2.2 | 2.4 | 3.0 |
| Thumb length | 1.6 | 1.8 | 2.0 | 2.7 |

The width of the inventive keyboard is approximately 15 inches. In contrast, a typical adult keyboard is approximately 17 inches in width. The rounded key top enables the child to more easily press the intended keys and makes it less likely for the child to accidentally hit an adjacent key. The size of a keyboard key is approximately a 0.5 inches circle on the top of the key. The key then tapers down to a larger size at its base; a little under 0.75 inches square (about 11/16ths of an inch). The tops of the keys also have a concave curvature on the top surface of each key. The top surfaces of the keys are also textured; roughened with minute bumps to improve traction and help reduce finger slippage. The inventive keyboard is easier for a child to use because it is more easily handled by the child, more intuitively organized and has a better fit with the child's hands.

The body of the keyboard may be a simple rectangular structure with rounded corners and adjustable feet at the front of the keyboard that allow the angle of the keyboard to be adjusted. The perimeter of the keyboard may have a rounded edge and curves. All sharp corners or sharp edges which may cause injury if the keyboard is dropped onto a limb have been removed. The keys of the keyboard are positioned away from the edges so that there is one or more inches of border between the keys and the edge of the keyboard. This border allows the child to easily grasp the keyboard and move it without depressing any of the keys.

Another feature of the keyboard is its ability to resist damage when liquids are split onto the keys. With reference to FIGS. 1 and 2, the inventive keyboard 101 has two groups of keys, a lower group of letters 103, 105, punctuation key 115 and functional keys 113, 115, 117 and an upper group of number 107 and functional keys. In an embodiment, the two groups of keys each occupy two distinct rectangular recesses 171, 173 in the keyboard frame. The inventive keyboard 101 has drains 179 that allow liquids spilt these recesses 171, 173 to flow through the drains 179 to the bottom of the keyboard 101. The drains 179 may be located at the lower corners of the two recesses 171, 173. When a liquid is spilt onto the inventive keyboard 101, it flows over the keys and into one of the rectangular recesses in the keyboard 171, 173. Because the keyboard naturally tilts up at the front, the liquid flows around the keys to the lower edge 175 of the lower recesses 171 and to the lower edge 177 of the upper recess 173. The liquid accumulates at the lower edges 175, 177 and flows through the drains 179. If the liquid remains in the recess, the user can tilt the keyboard 101 to the left or right so that the remaining liquid will flow to one of the drains 179 and out of the keyboard 101.

Although the liquids contact the recesses in the keyboard, it may not damage the functionality of the keys. As shown in FIG. 2, the keys are connected to posts 181 which fit into slots in raised sections 187. Thus, the sliding contact area between the posts 181 and the slots 185 are protected from the liquids. When the liquid is spilt onto the keyboard 101, it flows over the keys which diverts it away from the posts 181 and slots 185. As the fluids flow down to the lower edge 175 of the lower recess 171 and the lower edge 177 of the upper recess 173, the fluids flow around the raised sections 187. Thus, the raised sections 187 also protect the fluids from contacting the sliding contact areas between the posts 181 and slots 185.

In an embodiment, the inventive keyboard has a light that indicates that the “cap lock” key 123 is engaged. In another embodiment, the keys may have lights which are illuminate the entire keyboard or only illuminate the individual keys when the key is pressed. When the shift key is depressed, the symbol text on the number keys may be illuminated so that the child will know that pressing the shift key will result in a symbol being typed. In this embodiment, small lights under the keys may be illuminated when the shift key is pressed and the light may pass through the translucent symbol portion of the keys. In yet another embodiment, the keys may have a glow-in-the-dark material which allows the child to identify the keys in the dark.

In addition to the color scheme of the keys, the body of the keyboard may also have various colors, solid or patterned colors which may also include drawings or graphical designs. These designs and colors may be related to a theme, program or a specific institution. For example, if the product is associated with a television show, the graphics of the television characters may be printed on the boarder space of the keyboard. The keyboard may be packaged with various stickers which would allow the child to personalize the keyboard. For example, a set of letters or names as well as other graphics representing the interests of the child can be applied to the borders of the keyboard.

A common problem that children have when learning to type is that the keys can repeat if the key is not released quickly after being pressed. In an embodiment, the number, letter, punctuation and most symbol keys cannot be repeated even when the keys are held down. The inventive keyboard only allows the underscore and dash symbols to be repeated when these keys are held down. Some other keys may also be repeated such as the space bar or lines. By eliminating the repeat feature for most of the keys, the child will be less likely to accidentally make typing errors due to not releasing the key or typing to slowly and accidentally actuating the key repeat function.

In embodiments, the inventive keyboard includes mechanisms for preventing the computer from repeating the number and letter keys. In an embodiment special software is used with the inventive keyboard to prevent the letters and numbers from repeating. The software may be loaded onto a microprocessor in the computer as a keyboard driver. In another embodiment, the mechanism used to disable the repeat function is firmware is loaded onto a memory device in and run on a microprocessor in the keyboard. The firmware causes the keyboard to transmit only non-repeating key stroke signals for all letter and number keys. In yet another embodiment, a hardware device such as electrical circuitry transforms the keystroke signals into short single character keystrokes regardless of how long the key is pressed.

Another problem with children using computers, is that they can accidentally damage a computer by accessing or deleting certain program and data files. In an embodiment, the inventive keyboard may prevent the child from accessing or damaging the computer by applying a setting that disables all but the most basic program functions. In particular, when the keyboard is in a safe mode the “delete”, “replace”, “save as” and any controls which may cause data to be lost are completely disabled. Like the disabling of the repeat function, the safe mode function can be implemented through software, firmware or hardware. By setting the keyboard to this save mode, the child can freely use the inventive keyboard without causing any damage or make any functional changes to the computer, documents or software.

In an embodiment, the keys may be customized with “skins” which are thin plastic pieces which are attached to the keys. The skins may be held to the keys with an adhesive, plastic tabs or small magnets which are in the keys and skins. The skins may also be made of a soft material or a rubber material that resists the child's fingers from slipping off.

The inventive keyboard may be connected to the computer via a cable which has a plug which connects directly to the computer. The plug may be a dedicated PS/2 keyboard plug or a USB type plug. The keyboard is compatible with the various operating systems including: Windows 95, 98, 2000, Windows XP, all future Microsoft operating systems and all Apple Macintosh operating systems. Alternatively, the keyboard may have a wireless transmitter which transmits the keystroke signals as they are typed to a receiver which is connected to the computer. Examples of wireless communications include radio frequency (RF) or infrared. Communications between the computer and keyboard may be bidirectional or unidirectional with data traveling only from the keyboard to the computer.

The keyboard translates the motion of the fingers into text-based commands sent to the PC. Each of the keys are attached to a keyswitch which is an electrical switch. A separate keyswitch is associated with each key of the keyboard. When a key is pressed, the corresponding keyswitch is actuated. In an embodiment, the inventive keyboard uses membrane type contact keyswitches. When the key is pressed a rubber layer deforms, a carbon pad touches the contacts actuating the electrical switch.

The keyboard also has internal circuitry that handles the processing of keystrokes and exchanging information with the computer. In an embodiment, the keyboard has an internal microprocessor and read-only memory (ROM) that is similar to the system BIOS code on the computer's motherboard. The keyboard may also include EEPROM memory to store programming information. This internal circuitry is responsible for sensing the raw signals created by the keyswitches as they make electrical contact, and translating the keystroke signals into signals that are sent to the computer. The keyboard's internal circuitry also handles the actual interfacing between the keyboard and the rest of the PC system. The interface between the PC and the keyboard is a full bi-directional serial communications line that utilizes special protocols and commands.

In an embodiment, the inventive keyboard also includes a cable that runs between the main case of the keyboard, and the connector that attaches to the rest of the system. The cable contains four wires, corresponding to the four signal lines used for interfacing to the PC through the keyboard connector. A USB connector attached to the end of the cable. Some older computers may not have USB connectors, so the keyboard also includes a 6-pin mini-DIN adapter. The pins and signals associated with each pin are listed in the table below. As indicated above, there are only four actual signals used in the standard keyboard interface.

TABLE 4

| Pin # | 6-pin “mini-DIN” Connector |
|---|---|
| 1 | Keyboard Data |
| 2 | (not connected) |
| 3 | Ground |
| 4 | Power (+5 V) |
| 5 | Keyboard Clock |
| 6 | (not connected) |

When the keyboard is used with the USB connector it can be used as a second supplemental keyboard to the primary keyboard that is connected to the computer through the mini-DIN connector. By using the USB port, two keyboards can be connected to the computer simultaneously. In this configuration, an adult may be the primary user and a child may be the secondary user with either keyboard being filly functional. The two keyboards may even be used simultaneously. Two functional keyboards may be particularly useful when an adult is teaching a child how to use a computer. The adult can set up the computer with the primary keyboard and let the child use the inventive simplified keyboard to perform various computer actions under supervision.

The keyboard case holds all of the internal components of the keyboard, including the keys, the processing circuitry, an LED indicator and the keyswitches. The LED indicates that the cap lock is engaged. The case has a rounded shape and includes a wide perimeter area around the keys for grasping the keyboard. The keyboard also has feet with small rubber pads that provide traction for the keyboard, holding it in place so it cannot move around while being used. The keyboard also has angle adjuster tabs on the bottom of the keyboard case. These tabs are used to adjust the tilt of the keyboard, to provide a comfortable angle between the keyboard and the hands for a variety of users. The tabs have a locking mechanism to hold the adjusters in position.

The inventive keyboard draws some power from the computer's motherboard. Two of the wires that run through the keyboard cable carry a +5 volt power signal and ground signal from the motherboard to the keyboard. As discussed above, the keyswitches respond to mechanical motion of the user by creating an electrical signal that tells the keyboard's internal controller that “a key was pressed”. The internal circuitry then determines which key has been actuated and communicates this information to the computer. The keyswitches are arranged in a matrix of linear rows and columns. When a specific key is pressed, it generates a signal for the row and column assigned to that key. The keyboard controller is programmed to know that, for example, the letter “T” is at row #4 and column #6 in the matrix. A different combination of row and column signals exists for every other key in the keyboard.

After the keystroke has been registered, the keyboard controller generates special “scan” codes that indicate what key has been pressed. Each key on the keyboard has two scan codes. The first scan code is called the make code and is sent through the cord to the computer when the key is pushed. The second scan code is called the break code and is sent when the key is released. Using two codes, the PC system can determine not only what keys were pressed, but for how long, and also which keys have been held down during a specific period of time. This dual-code system also facilitates the multiple-key combinations and the controller can detect when multiple keys are pressed simultaneously. The multiple keys are typically control keys in combination with letters or other control keys: Ctrl+A, Ctrl+Alt+Delete, or Alt+Tab. Each key on the keyboard has its own scan code make-break pair; this is true even if there are two or three keys that are the same. The PC can also tell the difference between the left and right Shift keys.

In an embodiment, the inventive keyboard uses a universal serial bus (USB) to connect the keyboard to the PC. The traditional keyboard interface is over conductors in the keyboard cable which connect the internal controller in the keyboard with a matching device on the motherboard called the keyboard controller. All keyboards that use standard keyboard connectors to attach to the motherboard use the regular keyboard interface. In an embodiment, the inventive keyboard has a 6-pin mini-DIN adapter which can be connected to the USB connector. Communication over the interface is accomplished using two signaling lines, and is governed by a number of special rules and protocols, as described in the page on interface signaling. The communication is bi-directional, with the keyboard's internal controller and the motherboard's keyboard controller each able to send and receive commands over the interface.

The USB is a general-purpose, multi-functional serial interface for various devices including: keyboards, mice, printers, scanners and storage devices. The interface between the keyboard and the keyboard controller on the motherboard is a communications channel, over which commands and data are passed. The keyboard interface uses specific signaling protocols and standards to ensure that the keyboard can communicate with the PC system. The standard keyboard interface is a serial communications link with data sent one bit at a time over a single line. There are four lines that comprise the channel between the PC and the keyboard: the power and ground lines which provide power to the keyboard and the two signaling lines. The first signal line is the Keyboard Data line over which data bits are sent to the system from the keyboard and commands are sent from the system to the keyboard. The second signal line is the Keyboard Clock that is a repetitive, regular clock signal with a value that switches from 1 to 0 to 1 to 0 in a regular pattern. The clock signal synchronizes the keyboard and the system.

In the foregoing, a computer keyboard system has been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A computer keyboard comprising:
a frame;
a set of letter keys arranged in a QWERTY layout and mounted to an upper surface of the frame;
a set of number keys arranged in a sequential and linear configuration parallel to the top row of the QWERTY layout and mounted to the upper surface of the frame; and
a gap that separates the top row of QWERTY layout from the number keys.

2. The computer keyboard of claim 1, further comprising:
a mechanism for disabling a key repeat function for all letters and numbers.

3. The computer keyboard of claim 2 wherein the mechanism for disabling the key repeat function is a firmware program stored in a first electronic memory in the frame of the computer keyboard.

4. The computer keyboard of claim 2 wherein the mechanism for disabling the key repeat function is a software program stored in a second electronic memory in a computer associated with the computer keyboard.

5. The computer keyboard of claim 1 further comprising:
a first recess in which at least some of the set of letter keys are positioned;
a second recess in which at least some of the set of number keys are positioned; and
a drain that provides a path for liquids to flow from the recess out of the keyboard.

6. The computer keyboard of claim 1 wherein the set of letter keys have vowel keys that are a first color and consonant keys which are a second color.

7. The computer keyboard of claim 1 wherein the number keys are a third color that is distinct from the second color of the consonant keys.

8. The computer keyboard of claim 1 further comprising:
a shift key having text in a fourth color printed on a surface of the shift key;
wherein the number keys each have a symbol in the forth color printed on a surface of the number keys.

9. A computer keyboard comprising:
a frame;
a set of letter keys arranged in a QWERTY layout and mounted to an upper surface of the frame;
a set of number keys arranged in a sequential and linear configuration parallel to the top row of the QWERTY layout and mounted to the upper surface of the frame; and
a mechanism for disabling a key repeat function for all letters and numbers.

10. The computer keyboard of claim 9 wherein the mechanism for disabling the key repeat function is a firmware program loaded into a first electronic memory in the frame of the computer keyboard.

11. The computer keyboard of claim 9 wherein the mechanism for disabling the key repeat function is a software program loaded into a second electronic memory in a computer associated with the computer keyboard.

12. The computer keyboard of claim 9 wherein the set of letter keys have vowel keys that are a first color and consonant keys which are a second color.

13. The computer keyboard of claim 9 wherein the number keys are a third color that is distinct from the second color of the consonant keys.

14. The computer keyboard of claim 9 further comprising:
a shift key having text in a fourth color printed on a surface of the shift key;
wherein the number keys each have a symbol in the forth color printed on a surface of the number keys.

15. A computer keyboard comprising:
a frame;
a set of letter keys arranged in a QWERTY layout and mounted to an upper surface of the frame; and
a mechanism for disabling a key repeat function for all letters and numbers.

16. The computer keyboard of claim 15 wherein the mechanism for disabling the key repeat function is a firmware program loaded into a first electronic memory in the frame of the computer keyboard.

17. The computer keyboard of claim 15 wherein the mechanism for disabling the key repeat function is a software program loaded into a second electronic memory in a computer associated with the computer keyboard.

18. The computer keyboard of claim 15 further comprising:
a USB type connector which allows the computer keyboard to be used as a secondary keyboard for a computer.

19. The computer keyboard of claim 15 further comprising:
a recess in which at least some of the set of letter keys are positioned; and
a drain that provides a path for liquids to flow from the recess out of the keyboard.

20. The computer keyboard of claim 15 further comprising:
a set of number keys each have a symbol printed in a third color on a surface of the number key; and
a shift key having text printed in the third color on a surface of the shift key.
